(19) United States
(12) Patent Application Publication
(10) Pub. No.: US 2011/0277795 A1
(43) Pub. Date: Nov. 17, 2011

(54) Apparatus for washing material

(76) Inventor: Simon Mendenhall, Ashland, OR (US)

(21) Appl. No.: 12/800,411

(22) Filed: May 14, 2010

(51) Int. Cl. B08B 3/00

(52) U.S. Cl. 134/25.1; 134/121

(57) ABSTRACT

Disclosed herein is a washing apparatus comprising a cylindrical holding tank, a tumbler cage within the cylindrical holding tank adapted to rotate around a longitudinal axis within the cylindrical holding tank, and a support assembly comprising a plurality of axles which engage the cylindrical holding tank, such as through rollers, and allow the cylindrical holding tank to rotate around the longitudinal axis. Further disclosed are methods of using the apparatus to wash material, such as lightweight expanded clay aggregate.

### FIELD

Material washing apparatus and methods.

### BACKGROUND

Clay aggregate is used as media in growing plants to provide a structure for plant root growth. Clay aggregate is generally acquired by the consumers from a retail store in bulk. Such clay aggregate has dust and debris from the manufacturing process and/or from transport. Thus, prior to using newly purchased clay aggregate, users desire to remove the dust and debris clear from the media. Clay aggregate can also be reused as a growing media, but it is necessary to remove the soil and debris, such as roots, from the prior use before reusing the clay aggregate as a growing media for new plants.

The most common method of treating new clay aggregate from a retailer is to punch holes in the bottom of the bag in which it was packaged and, while standing above the bag holding the clay aggregate, manually inserting a water hose into said bag. Then a person must spray water into the bag and shake the bag to allow dust and debris to exit the bottom of the bag. This technique is inefficient and does not remove all dust and debris. Therefore before a person uses the clay aggregate, they must again hand rinse each basket of clay aggregate in a sink or under a bathtub spout.

With respect to used clay aggregate, a common method of cleaning the material is with use of a basket strainer. A person pours used clay aggregate in the basket and hand-rinses the aggregate under a bathtub spout or sink faucet. The person must manually shake and gyrate the basket while water pours through and removes roots and debris. This process is very time consuming, and painful. Sitting on the edge of, for example, a bathtub and bending over while hand rinsing baskets of aggregate can cause injury and is not an efficient method of rinsing said media. Further, after the clay aggregate has been rinsed free of root material it is placed in a large reservoir and soaked in a cleaning solution. It is difficult to ensure that the cleaning solution touches most or all of the surfaces of each piece of aggregate. It is also difficult to effectively rinse the clay aggregate in the large reservoir.

People have also tried to use a standard clothes washing machine but have had very little success. Attempts at converting a cement mixer to treat clay aggregate have also been short of success. Plastic bins have been drilled with holes in an attempt to rinse hydroton. These plastic bins have been found to be difficult to use and awkward.

Due to lack of a better technique than those described, most clay aggregate growing media users discard the used clay aggregate after each growing cycle. Some manufacturers have developed media other than clay aggregate that they advertise as better than clay aggregate for the simple reason that their product does not require pre-use washing in view of the aforementioned difficulties faced.

Thus, there is a need for an apparatus which efficiently washes clay aggregate.

### SUMMARY

Disclosed herein is a washing apparatus comprising a cylindrical holding tank, a tumbler cage within the cylindrical holding tank adapted to rotate around a longitudinal axis within the cylindrical holding tank, and a support assembly comprising a plurality of axles which engage the cylindrical holding tank, for example through integral or attached rollers, and allow the cylindrical holding tank to rotate around the longitudinal axis.

The cylindrical holding tank comprises a cylindrical wall portion which has a cylindrical holding tank access port adapted to allow material to pass in to and out of the cylindrical holding tank, and wherein the tumbler cage is suspended within the cylindrical holding tank by a drive shaft which passes through the longitudinal axis of the tumbler cage and the cylindrical holding tank wherein the drive draft also engages the tumbler cage to cause the tumbler cage to rotate around the longitudinal axis when the drive shaft is rotated, which drive shaft in turn is suspended within the cylindrical holding tank through engagement of the drive shaft with the side walls of the cylindrical holding tank.

The tumbler cage has a tumbler cage loading door adapted to allow material to pass in to and out of the tumbler cage, wherein the loading door is positioned on the tumbler cage to be alignable with the access port so as to allow material to passed through the access port and the loading door while both the access port and the loading door remain rotationally static. There is a fluid inlet engageable with an external fluid supply to allow fluid to enter the cylindrical holding tank through the cylindrical wall portion of the cylindrical holding tank. In some cases the fluid inlet comprises a hose adapter to receive fluid from an external fluid supply and one or more sprayers adapted to spray fluid into the cylindrical holding tank and oriented to spray fluid onto the tumbler cage. The washing apparatus has a fluid outlet to allow fluid to exit the cylindrical holding tank through the cylindrical wall portion of the cylindrical holding tank.

The support assembly supports the cylindrical holding tank and in some cases comprises two or more axles, wherein the axles engage the cylindrical holding tank and allow the cylindrical holding tank to rotate around the longitudinal axis. In some embodiments, each axle has a plurality of rollers adapted to rotate on the axle, wherein the axle engages the cylindrical holding tank through rollers that engage the cylindrical holding tank and allow the cylindrical holding tank to rotate around the longitudinal axis.

In some cases the exterior side of the wall portion of the cylindrical holding tank has one or more circumferential guides, wherein each circumferential guide is engageable with one or more of the rollers.

In use, the apparatus may be operated by situating material to be washed for washing by aligning the cylindrical holding tank access port and the tumbler cage loading port and placing the material to be washed into the tumbler cage; securing the cylindrical holding tank access port with a cylindrical holding tank loading door and the tumbler cage loading port with a tumbler cage loading door; rinsing the material by engaging the fluid inlet with an external fluid supply to allow fluid to enter the cylindrical holding tank and spray the material with fluid and allow the fluid to pass through the fluid outlet; filling the cylindrical holding tank with fluid by closing the fluid outlet and allowing the fluid to fill the cylindrical holding tank at least until the fluid contacts the material in the tumbler cage; agitating the material by turning the tumbler cage; opening the fluid outlet and allowing the fluid to pass through the fluid outlet; rinsing the material again by engaging the fluid inlet with an external fluid supply to allow fluid to enter the cylindrical holding tank and spray the material with fluid and allowing the fluid to pass through the fluid outlet; and removing the washed material from the apparatus by rotating the cylindrical holding tank until the holding tank access port faces downward, opening the cylindrical holding tank loading door, rotating the tumbler cage until the tumbler cage access port is aligned with the holding tank access port, opening the tumbler cage loading door and allowing the washed material to fall from tumbler cage and through the holding tank access port.

A particular example of the material that the apparatus is designed to wash is lightweight expanded clay aggregate, which is some cases is known as Hydroton. Thus is operation the material being washed may be lightweight expanded clay aggregate. The washing process may also include the use of a cleaning solution such as a soap or bleach or another cleaning agent.

After the material is washed or rinsed in the apparatus, the material can be easily deposited into a container by placing a container below the apparatus and allowing the washed material to fall from tumbler cage and through the holding tank access port into the container.

The foregoing and other objects, features, and advantages of the invention will become more apparent from the following detailed description, which proceeds with reference to the accompanying figures.

### BRIEF DESCRIPTION OF THE DRAWINGS

FIG. 1 is a perspective view of an embodiment of the disclosed washing apparatus.

FIG. 2A is a cross sectional view along A-A of a portion of the disclosed washing apparatus shown in FIG. 1.

FIG. 2B is an exploded cross sectional view of the drainage outlet and surrounding portion of the disclosed washing apparatus as indicated in FIG. 2A.

FIG. 3 is a perspective view of an embodiment of the disclosed washing apparatus shown in FIG. 1 wherein the cylindrical holding tank has been rotated toward the viewer.

FIG. 4 is a perspective view of the tumbler cage and corresponding tumbler cage loading door.

### DETAILED DESCRIPTION

Disclosed herein is an apparatus for washing material, such as growing media, for example, clay aggregate such as lightweight expanded clay aggregate, comprising a cylindrical holding tank, a tumbler cage within the cylindrical holding tank adapted to rotate around a longitudinal axis within the cylindrical holding tank, a support assembly comprising a frame and a plurality of axles which engage the cylindrical holding tank and allow the cylindrical holding tank to rotate around the longitudinal axis. In operation, the material is placed in the tumbler cage and the cylindrical holding tank is filled fully or partially with a fluid such as water and/or a bleach solution to wet the material and allow debris to be separated from the material and carried away by the fluid. The apparatus is especially suited for cleaning new lightweight expanded clay aggregate prior to use as a media for growing plants, and for cleaning lightweight expanded clay aggregate that has been used as a media for growing plants so that the lightweight expanded clay aggregate can be used again.

As noted, the washing apparatus comprises a cylindrical holding tank. The cylindrical holding tank comprises a cylindrical wall portion and first and second side walls. The cylindrical holding tank may be made of plastic, or rubber, or steel, or wood, or any other material sufficiently strong enough to maintain structural integrity when filled with a fluid such as water. In particular embodiments, the cylindrical holding tank is made of plastic. For example, in a specific embodiment the tank is a 55 gallon plastic food grade barrel with a screw top.

The first and second side walls may be formed integrally with the cylindrical holding tank or may be attached to the cylindrical wall portion. For example, in some cases stainless steel discs are attached to a plastic cylindrical wall portion by use of adhesive bonding agent, such as a glue, for example a marine epoxy.

An exterior side of the wall portion of the cylindrical holding tank may have one or more circumferential guides. Such circumferential guides may be, for example, channels formed from in the cylindrical wall portion or ribs formed in the cylindrical wall portion or attached thereto.

The cylindrical holding tank has a cylindrical holding tank access port in the cylindrical wall portion adapted to allow material to pass in to and out of the cylindrical holding tank. This access port may be any means of allowing access between two sides of a wall. For example, in some cases the access port is created by cutting out a square or rectangular portion (or any other geometric shape) of the wall portion cylindrical holding tank and attaching the cut out portion of the wall portion back to the cylindrical holding tank using hinges which can be attached with rivets, glue, and/or nuts and bolts. In other cases a louvered door, or a door adapted to slide open and closed on a rolling system parallel to the longitudinal axis might be used.

The cylindrical holding tank has a fluid inlet to allow fluid to enter the cylindrical holding tank through the cylindrical wall portion of the cylindrical holding tank. The fluid inlet is any means that allows fluid to pass in to the cylindrical holding tank. For example, the fluid inlet might comprise a circular hole in the cylindrical wall of the cylindrical holding tank adapted to receive a hose through which water can be supplied into the interior of the cylindrical holding tank. In a particular embodiment, the fluid inlet comprises a sprinkler assembly mounted through and on the cylindrical wall portion of the cylindrical holding tank. In this embodiment, the sprinkler assembly includes a fluid supply adapter attached to a shut of valve attached to an elbow fitting, wherein the water supply adapter attached to a shut of valve are outside of the cylindrical holding tank and the elbow fitting passes through a hole in the cylindrical wall portion of the cylindrical holding tank and further connects to a fluid line inside of the cylindrical holding tank. The fitting may be secured in the hole in the cylindrical wall portion of the cylindrical holding tank with rubber grommets. The fluid line has a plurality of sprayers oriented to spray fluid into the cylindrical holding tank and/or onto a tumbler cage. The fluid line can be a flexible black polyvinyl pipe or corrugated stainless steel tube. Both need to be flexible to bend to the inside shape of the barrel. In some embodiments the fluid line is positioned to be substantially parallel to the longitudinal axis. The sprayers can be conventional sprinkler heads such as bow tie sprayers or micro sprayers, or could be pressurizing recesses formed within the fluid line.

The first and second side walls of cylindrical holding tank are adapted to support a drive shaft which passes through the longitudinal axis of the cylindrical holding tank. In some cases, cast iron sealed block bearings are bolted to the first and second side walls and these block bearings are used to support the drive shaft within the cylindrical holding tank. Bearings may need a bead of silicon caulking to secure seal to side walls.

The drive shaft extends through the first side wall and engages a drive means, such as a handle or a drive motor. When powered, e.g., by a drive motor or a person, the drive means may cause the drive shaft to rotate.

In some embodiments one or more handles may be attached to the exterior of the cylindrical holding tank to allow the cylindrical holding tank to be maneuvered. In certain cases, a handle is attached to the cylindrical holding tank on an end of the cylindrical holding tank near the first side wall and another handle is attached to the cylindrical holding tank on an end of the cylindrical holding tank near the second side wall. These handles may both be positioned on a line parallel to the longitudinal axis.

The cylindrical holding tank may also have a fluid outlet to allow fluid to exit the cylindrical holding tank through the cylindrical wall portion of the cylindrical holding tank. This may comprise simply a hole cut into the cylindrical wall portion of the cylindrical holding tank which may be opened or closed, for example with a plug, such as a rubber plug or cork plug, depending on whether the fluid is desired to be retained in the holding tank or allowed to exit therefrom.

In some embodiments a drainage assembly is attached to the fluid outlet to allow for drainage of fluid into a particular receptacle, such as a sewer drain, and to filter debris and other items from the fluid prior to the fluid entering a particular receptacle. In a particular embodiment, a drainage assembly comprises a drain hose adapted to couple to the fluid outlet, such as by a compression fitting, for example an assembly comprising a conduit with a lip on one end that engages the interior of the cylindrical holding tank and threads on the other end which engage a conduit lock nut wherein the conduit lock nut can slide over the drain hose to engage the threads to hold the conduit against the wall of the cylindrical holding tank. A compression nut may also fit over the drain hose and, when tightened onto the threads of the conduit, hold the drain hose against conduit by a compression fit. The drain assembly may further comprise a valve that can be opened and closed, e.g., with a handle, to allow or prevent drainage of fluid from the cylindrical holding tank. In some cases the drain hose, or a portion thereof is made from transparent, e.g., clear, material to allow for visual inspection of the fluid being drained from the cylindrical holding tank. The drain hose has a diameter sufficient to allow debris such as roots and clay aggregate to travel through the hose which, in some cases is about an inch. In certain embodiments, a drainage basket is coupled to the drain hose so that fluid must pass through the drainage basket before entering a further receptacle, such as a sewer. The drainage basket is porous and may be adapted to filter out particles over a certain size. For example, a drainage basket might have circular, square, or rectangular pores (or any other geometric shape or combination thereof) no larger than about a half inch. In particular, for usage in washing lightweight expanded clay aggregate, the pores might be square and about a quarter inch on a side.

The washing apparatus further comprises a tumbler cage within the cylindrical holding tank adapted to rotate around the longitudinal axis within the cylindrical holding tank. The tumbler cage is suspended within the cylindrical holding tank through engagement of the drive shaft, such as by welded tacks or shaft collars. Rotation of the drive shaft causes the tumbler cage to rotate around the drive shaft within the cylindrical holding tank.

The tumbler cage is a porous container adapted to receive material to be washed, such as lightweight expanded clay aggregate. The tumbler cage may be made of plastic, or rubber, or steel, or wood, or any other material of combination thereof sufficiently strong enough to maintain structural integrity when filled with material to be washed, such as lightweight expanded clay aggregate and submerged in fluid such as water.

The tumbler cage may be a cylinder, or a cube, or a sphere. In particular embodiments the tumbler cage is cylindrical and has a cylindrical wall portion formed from wire mesh wrapped around and attached to stainless steel support members and first and second side walls made of stainless steel discs to which the stainless steel support members are attached. In certain embodiments, removable clips, zip ties or welded tacks hold the wire mesh to the support members. Removable clips may be preferred in some cases as they allow an operator of the apparatus to manually change the size to the mesh to suit particular products to be cleaned. The support members are tack welded to the side walls.

The tumbler cage has a tumbler cage loading port adapted to allow material to pass in to and out of the tumbler cage and to be securable with a tumbler cage loading door in its closed position so that it does not open during operation of the apparatus. The loading port is positioned on the tumbler cage so as to be alignable with the access port of the cylindrical holding tank so as to allow material to pass through the access port and the loading port while both the access port and the loading port remain rotationally static.

The loading port may be any means of allowing access between two sides of a wall. For example, in some cases where the tumbler cage is cylindrical the loading port is created by cutting out a square or rectangular portion (or any other geometric shape having a flat end) of the cylindrical wall portion of the tumbler cage and is securable with a loading door made by attaching the cut out portion of the wall portion back to the cylindrical holding tank using hinges and rivets, glue, and/or bolts. In other cases a louvered door, or a door adapted to slide open and closed on a rolling system parallel to the longitudinal axis might be used.

In a specific embodiment of a cylindrical tumbler cage formed from wire mesh wrapped around and attached to stainless steel support members and first and second side walls made of stainless steel discs to which the stainless steel support members are attached, the loading door is made by bending a paint grate or bucket grate (that is, the grates painters place in paint buckets to even out the paint on the rollers) to meet the spherical shape of the tumbler cage. Wire mesh was then attached to said paint grate to match existing mesh on the tumbler. The loading door is secured shut by fitting the ends of the paint grate through slits cut into the wire mesh, and/or by a plurality of latches located on the tumbler support members. The latches are on the tumbler support members and the latch recesses are on the loading door.

In another example in which the tumbler cage is a sphere, the loading door is spherical and is removed and attached to the tumbler cage by threaded engagement between threads on the loading door and on the tumbler cage similar to a hamster ball.

The washing apparatus may further comprise a support assembly comprising a plurality of axles positioned on a frame to engage the cylindrical holding tank and allow the cylindrical holding tank to rotate around the longitudinal axis.

The frame comprises an axle support structure capable of supporting the axles and the cylindrical holding tank when the cylindrical holding tank is full of material to be washed and fluid. The frame may be made from metal or wood or plastic any other suitable material or combination thereof.

For example, in some cases, the frame comprises a rectangular form made of four wooden members attached together with, for example, screws and/or nails and corner brackets and a plurality, e.g., two, wooden interior support members attached to the longer wooden members of the rectangular form and parallel to the shorter sides of the rectangular form and spaced to allow removal of material from the tumbler cage and the cylindrical holding tank without significant interference with the interior support members, for example, in some cases the interior support members are spaced so as to divide the rectangle into thirds. In another example, the frame is a stainless steel circle.

The axles are attached to the frame such that they are parallel and positioned to engage the cylindrical holding tank. The axles can be attached to the frame by any conventional means and with regard for whether the axle is meant to rotate or remain static. In some cases the axles are attached to the top of the frame and secured to the frame by copper pipe straps. In other cases an axle may be attached to the frame by positioning the axle within an axel retention location, which might be a hole through the frame or a concavity within the frame.

The axles may be stainless steel rods or any other water resistant strong material (such as plastics, ceramics etc.).

The axles are adapted to allow cylindrical holding tank to rotate on the axles around the longitudinal axis. In certain embodiments one or more axles are able to rotate to allow the cylindrical holding tank to rotate on the axles around the longitudinal axis. In such embodiments the axles may be uniformly cylindrical, or they may comprise rolling contact points having a greater circumference than the remainder of the axles. In such embodiments it is these rolling contact points which contact the cylindrical holding tank. These rolling contact points may be formed integrally with the axles, or may comprise rollers, such as wheels or balls, fixedly attached to the axles (so that the rotation of the axles would drive rotation of the rollers).

In other embodiments, one or more of the axles are fixed (i.e., do not rotate), but rollers such as wheels or balls are suspended on the axle, which rollers engage the cylindrical holding tank and are able to rotate around the axle to allow the cylindrical holding tank to rotate around the longitudinal axis.

In certain embodiments, such as embodiments in which the cylindrical holding tank includes circumferential guide comprising a channel in the cylindrical wall portion of the cylindrical holding tank, one or more of the rollers engages the circumferential guide by engaging the channel and such a roller is relatively larger in radius than the other rollers in an amount equal to the depth of the channel.

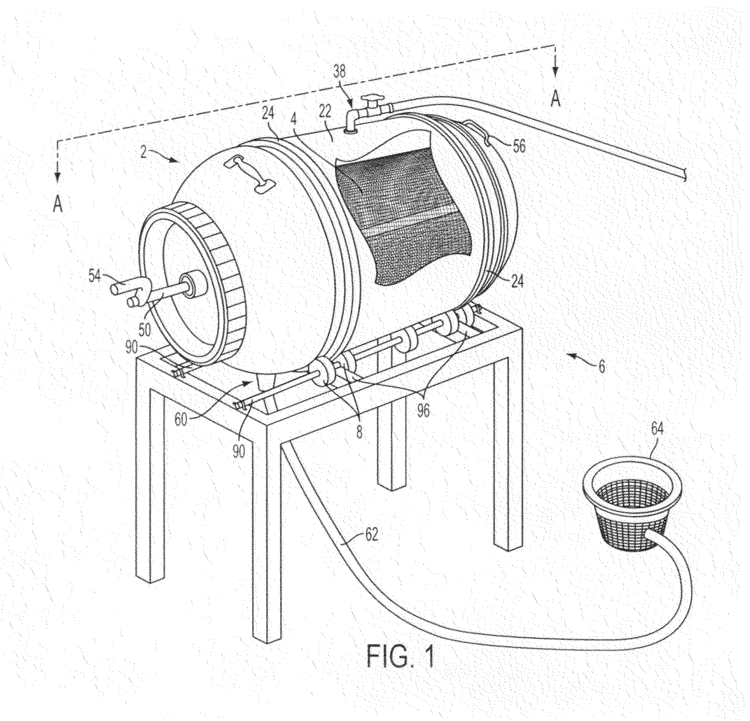

One embodiment of the apparatus for washing material is shown in FIGS. 1-4. With reference to FIG. 1, the apparatus for washing material comprises a cylindrical holding tank 2, a tumbler cage 4 within the cylindrical holding tank 2 adapted to rotate around a longitudinal axis within the cylindrical holding tank 2, a support assembly 6 comprising a plurality of axles 90 each having a plurality rollers 8 which engage the cylindrical holding tank 2 and allow the cylindrical holding tank 2 to rotate around the longitudinal axis (which axis runs through shaft 50).

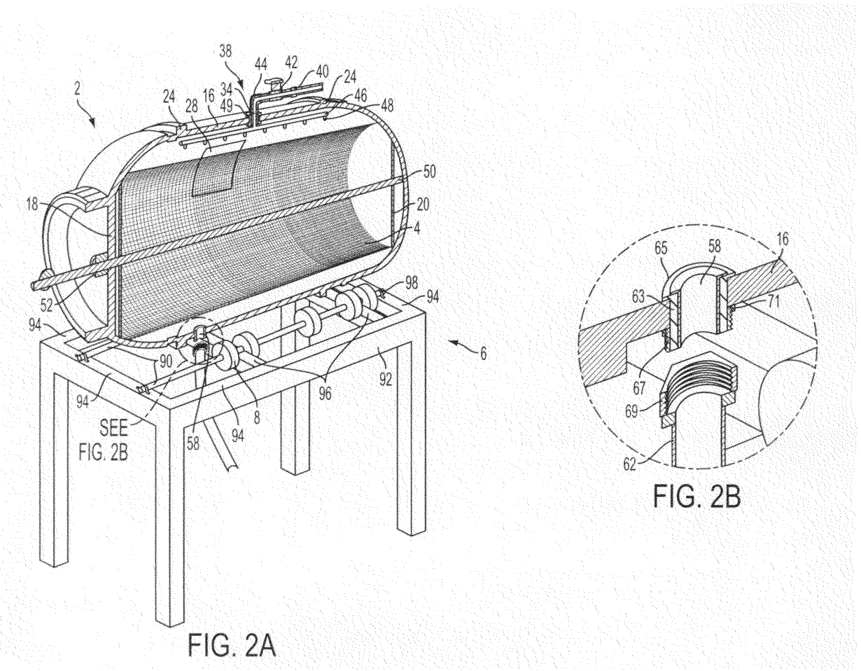

As can be seen in FIG. 2A the cylindrical holding tank 2 comprises a cylindrical wall portion 16 and a first side wall 18 and a second side wall 20. The cylindrical holding tank 2 in this embodiment is made of plastic and is adapted from a 55 gallon plastic food grade barrel.

The first 18 and second 20 side walls in this embodiment are stainless steel discs attached to the plastic cylindrical wall portion 16 with glue.

With reference to FIG. 2A the exterior side of the cylindrical wall portion 16 of the cylindrical holding tank 2 has multiple circumferential guides 24. These circumferential guides are ribs formed in the cylindrical wall portion 16 of cylindrical holding tank 2.

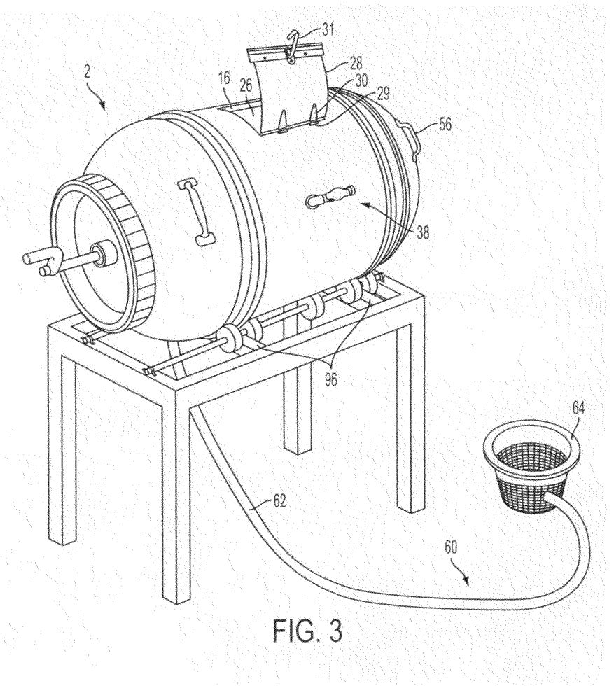

With reference to FIG. 3, the cylindrical holding tank 2 has a cylindrical holding tank access port 26 in the cylindrical wall portion 16 which can be opened and closed to allow material to pass in to and out of the cylindrical holding tank 2. In this embodiment the access port 26 is created by cutting out a rectangular portion of the cylindrical wall portion 16 of cylindrical holding tank 2 to form a cylindrical holding tank loading door 28 which is attached to the cylindrical holding tank 2 using hinges 30 that are attached to the door 28 and the cylindrical holding tank 2 using stainless steel bolts and nuts. The loading door has a sealing member 29, which may be a piece of weather stripping attached to the loading door with, for example, an adhesive, rivets, or nuts and bolts, and a latch 31 which can engage a member (not shown) on the cylindrical holding tank to hold the door shut.

With reference to FIG. 2A, the cylindrical holding tank 2 has a fluid inlet 34 comprising a circular hole in the cylindrical wall 16 of the cylindrical holding tank 2 to allow fluid to enter the cylindrical holding tank 2 through the cylindrical wall portion 16 of the cylindrical holding tank 2. In this embodiment, the fluid inlet 34 is coupled to a fluid sprinkler assembly 38 mounted through and on the cylindrical wall portion 16 of the cylindrical holding tank 2. The sprinkler assembly 38 includes a fluid supply adapter 40 attached to a shut of valve 42 attached to an elbow fitting 44, wherein the water supply adapter 40 attached to the shut of valve 42 are outside of the cylindrical holding tank 2 and the elbow fitting 44 passes through the hole 34 in the cylindrical wall portion 16 of the cylindrical holding tank 2 and further connects to a fluid line 46 inside of the cylindrical holding tank 2. The fitting 44 is secured in the hole 34 in the cylindrical wall portion 16 of the cylindrical holding tank 2 with rubber grommets 49. The fluid line 46 has a plurality of sprayers 48 oriented to spray fluid into the cylindrical holding tank 2 and onto the tumbler cage 4. The fluid line 46 is a flexible black polyvinyl pipe. As can be seen, the fluid line 46 is substantially parallel to the longitudinal axis of the cylindrical holding tank 2. The sprayers 48 in this embodiment are micro sprayers.

The first 18 and second 20 side walls of cylindrical holding tank 2 are adapted to support a drive shaft 50 which passes through the longitudinal axis of the cylindrical holding tank 2. A cast iron sealed block bearing 52 is bolted to the first 18 side wall and a block bearing is also similarly bolted to the second side wall 20 and these block bearings are support the drive shaft 50 within the cylindrical holding tank 2.

The drive shaft 50 extends through the first side wall 18 and, with reference now to FIG. 1, engages a drive means, which in this case is a handle 54.

Two handles 56 are attached to the exterior of the cylindrical holding tank 2 to allow the cylindrical holding tank 2 to be maneuvered.

With reference to FIG. 2A, the cylindrical holding tank has a fluid outlet 58 to allow fluid to exit the cylindrical holding tank through the cylindrical wall portion 16 of the cylindrical holding tank 2. In this embodiment, the fluid outlet 58 is a hole cut into the cylindrical wall portion 16 of the cylindrical holding tank 2.

With reference to FIG. 1, a drainage assembly 60 is attached to the fluid outlet 58 as shown in an expanded view in FIG. 2B to allow for drainage of fluid into a particular receptacle, such as a sewer drain, and to filter debris and other items from the fluid prior to the fluid entering a particular receptacle. With reference to FIG. 2B, the drainage assembly comprises a drain hose 62 adapted to couple to a conduit 63 which passes through fluid outlet 58 which conduit 63 has a lip 65 on one end to seal the conduit against the interior side of the cylindrical wall portion 16 of the cylindrical holding tank and threads 67 on the other end to engage a locking nut 71 to hold the conduit in place against the cylindrical wall portion 16 of the cylindrical holding tank and to engage a compression nut 69 which fits over the drain hose 62 and when tightened onto the threads 67 of the conduit 63 holds the drain hose 62 against the conduit 63 to allow fluid to flow from the cylindrical holding tank and through the drain assembly 60. As shown in FIG. 1, a drainage basket 64 is coupled to the drain hose 62 so that fluid must pass through the drainage basket before entering a further receptacle, such as a sewer.

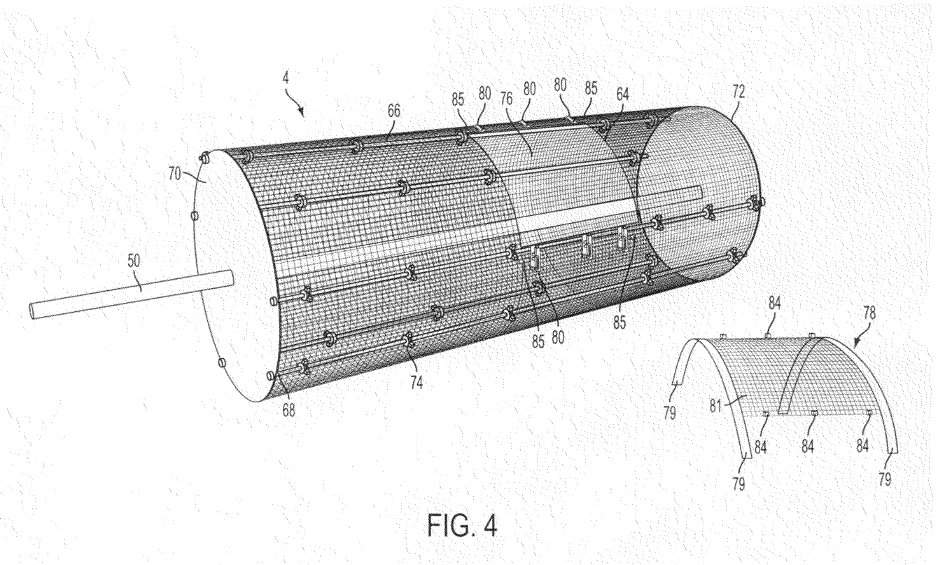

With reference to FIG. 2A, the tumbler cage 4 is within the cylindrical holding tank 2 and is suspended within the cylindrical holding tank 2 through engagement of the drive shaft 50. With reference to FIG. 4, the tumbler cage 4 is cylindrical and has a cylindrical wall portion 64 formed from wire mesh 66 wrapped around and attached to stainless steel support members 68 and first and second side walls, 70 and 72 respectively, made of stainless steel discs to which the stainless steel support members 68 are attached. The support members 68 are tack welded to the side walls 70 and 72. Removable clips 74 are used to couple the wire mesh to the support members.

The tumbler cage 4 has a tumbler cage loading port 76 adapted to allow material to pass in to and out of the tumbler cage 64 and to be securable with a tumbler cage loading door 78, which, when secured in a closed position prevents material from passing in to and out of the tumbler cage 64. The loading port 76 is positioned on the tumbler cage 64 so as to be alignable with the access port 26 of the cylindrical holding tank 2 shown in FIG. 2A so as to allow material to pass through the access port 26 and the loading port 76 while both the access port 26 and the loading port 76 remain rotationally static.

With reference again to FIG. 4, the tumbler cage loading door 78 is made by bending two loading door supports 79 (e.g., paint grates) to meet the cylindrical shape of the tumbler cage. Loading door wire mesh 81 is then attached to the two loading door supports 79 to match existing mesh 66 on the tumbler cage. The tumbler cage loading door 78 is secured shut by the use of three slide bolt latches 80 on each side of the tumbler cage loading port 76 each having a slide bolt 82 which slide bolts 82 can slide to engage corresponding latch recesses 84 on the loading door 78. The slide bolt latches 80 are attached to the mesh 66, such as by way of the use of attachment bolts through the latch 80 and the mesh 66 and secured with nuts on the opposite side of the mesh 66. The slide bolt recesses 84 are attached to mesh 81 in the same manner. Also, the distal portions of loading door supports 79 fit through slits 85 in the tumbler cage wire mesh 66 to further secure the tumbler cage loading door 78 over the loading port 76. In certain other embodiments, the loading door might be secured only by fitting the loading door supports though the slits and without use of slide bolts.

With reference to FIG. 2A, the support assembly 6 comprises a plurality of axles 90 positioned on a frame 92 to engage the cylindrical holding tank 2 and allow the cylindrical holding tank 2 to rotate around its longitudinal axis.

The frame 92 comprises an axle support structure capable of supporting the axles 90 and the cylindrical holding tank 2 when the cylindrical holding tank 2 is full of material to be washed and fluid. The frame 92 comprises a rectangular form made of four wooden members 94 and two wooden interior support members 96. The interior support members 96 are spaced wider apart than the width of the cylindrical holding tank access port 26 shown in FIG. 3 so as to allow material to be emptied from the tumbler cage and cylindrical holding tank without interference from the interior support members 96. In the embodiment depicted, the interior support members are set off to the right hand side, but they could also be spaced, for example equidistant from each other, or in any other configuration depending on the location of the cylindrical holding tank access port so as to allow removal material from the cylindrical holding tank without significant interference from the interior support members. Interior support member could also be omitted from the apparatus if sufficiently strong material is used for the axles.

The axles 90 are attached to the frame 92 such that they are parallel and positioned to engage the cylindrical holding tank 2. The axles 90 are attached to the top of the frame 92 and secured to the frame 92 by copper pipe straps 98. The axles 90 are stainless steel rods.

The axles 90 are fixed (i.e., do not rotate), but rollers 8, in this case wheels, are suspended on the axles 90, which rollers 8 engage the cylindrical holding tank 2 and arc able to rotate around the respective axles 90 to allow the cylindrical holding tank 2 to rotate around the longitudinal axis. Of course the rollers could also be fixed to rotatable axles to allow for rotation of the cylindrical holding tank 2.

In the illustrated embodiment, four of the rollers 8 on each axle 90 engage the circumferential guides 24 to stabilize the cylindrical holding tank 2.

In a method of using the apparatus for washing material described herein, such as the embodiment shown in FIGS. 1-4, material to be washed for washing is placed into the tumbler cage 4. This entails aligning the cylindrical holding tank access port 26 and the tumbler cage access port 76, opening the cylindrical holding tank loading door 28 and placing the material to be washed into the tumbler cage 4. In some cases the material is lightweight expanded clay aggregate, which is also known as Hydroton, which is used as a growing media for plants. In some cases, use of a funnel to direct the material into the tumbler cage 4 may be helpful. Then, the tumbler cage loading door 78 is secured to the tumbler cage 4 with the slide bolt latches 80 by engaging the slide bolts 82 with the corresponding latch recesses 84 on the loading door 78 and also by fitting the distal portions of loading door supports 79 fit through slits 85 in the tumbler cage wire mesh 66. In certain other methods, the loading door might be secured only by fitting the loading door supports though the slits and without use of slide bolts. The cylindrical holding tank loading door 28 is also closed and secured.

The material is then rinsed by engaging the fluid inlet with an external fluid supply to allow fluid such as water to enter the cylindrical holding tank 2 and spray the material with fluid and allow the fluid to pass through the fluid outlet 58 and drain assembly 60. During rinsing the tumbler cage may be turned using handle 54 to cause the tumbler cage to rotate about shaft 50 so as to expose more of the material to the fluid. Determining how long to rinse the material may include visually inspecting the fluid travelling through the drain hose 62 and continuing the rinsing process until the fluid moving though the drain hose is generally free or debris. The length of the rinsing period will be affected by the amount of fluid available through the external fluid supply. For example, if the water pressure of the external supply line is low, the rate of water delivered will be lower and rinsing times may be longer. The speed of rotation of the tumbler cage in resolutions per minute (RPM) may be any speed so long as the speed does not cause the apparatus to fail. However, in some cases, the tumbler cage is rotated at about 10-40 RPM, such as 30 RPM for about 8-10 minutes.

The cylindrical holding tank 2 is then filled with fluid by closing the fluid outlet and allowing the fluid to fill the cylindrical holding tank 2 at least until the fluid contacts the material in the tumbler cage 4. A cleaning solution such as bleach, hydrogen peroxide, a surfactant composition (including relatively environmentally friendly surfactant composition such as those primarily comprising alkyl polyglycosides as the surfactant), or a mixture of enzymes and bacteria adapted to consume organic waste (such as an environmentally friendly cleaning agent like BIO-CLEAN®) or a combination of these agents, may also be added to the fluid and material in the cylindrical holding tank to sanitize and/or increase the effectiveness of the washing of the material by removing additional debris from the material. In some cases the cleaning solution is added in a quantity such that the solution comprises about 80 to 100 parts per million of the cleaning solution and the fluid together. When a cleaning solution is used, the material may be allowed to soak in the cleaning solution and fluid. For example, in some cases the material is allowed to soak for 8-10 minutes. During such soaking, the tumbler cage may be turned periodically, such as every minute or two minutes, to expose a maximum surface area of the material to the fluid and cleaning solution.

The material is then rinsed again. In this process, the fluid outlet is opened to allow the fluid, cleaning solution, and debris to exit the cylindrical holding tank and the external fluid supply is again allowed to cause fluid to enter the cylindrical holding tank 2 and spray the material with fluid. During this rinsing the tumbler cage may be turned using handle 54 to cause the tumbler cage to rotate about shaft 50 so as to expose more of the material to the fluid. Determining how long to rinse the material may include, for example when a soap is used as a cleaning solution, visually inspecting the fluid travelling through the drain hose 62 and continuing the rinsing process until the fluid moving though the fluid travelling drain hose no longer appears to be sudsy. In other cases, the rinsing is continued for a sufficient time to substantially rinse the cleaning solution from the material. In some cases this time will be 4-15 minutes, such as 8-12 minutes, for example, 10 minutes. The speed of rotation of the tumbler cage in resolutions per minute (RPM) may be any speed so long as the speed does not cause the apparatus to fail. However, in some cases, the tumbler cage is rotated at about 10-40 RPM, such as 30 RPM during the rinsing. The tumbler cage could also simply be rotated periodically, such as two or three times per minute.

After the material has been rinsed, it is removed from the apparatus. In this process, the drain hose assembly 60 is disconnected to allow rotation of the cylindrical holding tank 2 and storage container for the material is placed below the cylindrical holding tank. The cylindrical holding tank 2 is rotated along its longitudinal axis on the axles and/or rollers until the cylindrical holding tank access port 26 faces downward. The cylindrical holding tank door 28 is opened and the tumbler cage 4 is rotated by using handle 54 to cause the tumbler cage to rotate about shaft 50 until the tumbler cage access port 76 is aligned with the holding tank access port 26. The tumbler cage loading door 78 is opened allowing the washed material to fall from tumbler cage 4 and through the holding tank access port 26 into the storage container. Of course the tumbler cage loading door 78 could also be opened prior to rotation of the cylindrical holding tank 2 and tumbler cage 4 for convenience if accessing the tumbler cage loading door 78 after rotation of the cylindrical holding tank 2 was considered less desirous by the user.

In another method of using the apparatus for washing material described herein, such as the embodiment shown in FIGS. 1-4, the material to be washed is new lightweight expanded clay aggregate, also known as Hydroton. Such new Hydroton may be contaminated with dust and debris from the manufacturing process or transit and users may desire to rinse the Hydroton prior to use as a growing media. In this method, only the initial rinsing step described above is performed, and then the Hydroton is removed from the cylindrical holding tank into the storage container.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. A washing apparatus comprising:
A cylindrical holding tank, a tumbler cage within the cylindrical holding tank adapted to rotate around a longitudinal axis within the cylindrical holding tank, and a support assembly comprising a plurality of axles which engage the cylindrical holding tank and allow the cylindrical holding tank to rotate around the longitudinal axis.

2. The washing apparatus of claim 1, wherein the cylindrical holding tank comprises a cylindrical wall portion which has a cylindrical holding tank access port adapted to allow material to pass in to and out of the cylindrical holding tank, and wherein the tumbler cage is suspended within the cylindrical holding tank by a drive shaft which passes through the longitudinal axis of the tumbler cage and the cylindrical holding tank wherein the drive draft also engages the tumbler cage to cause the tumbler cage to rotate around the longitudinal axis when the drive shaft is rotated, which drive shaft in turn is suspended within the cylindrical holding tank through engagement of the drive shaft with the side walls of the cylindrical holding tank.

3. The washing apparatus of claim 2, wherein the tumbler cage has a tumbler cage loading door adapted to allow material to pass in to and out of the tumbler cage, wherein the loading door is positioned on the tumbler cage to be alignable with the access port so as to allow material to passed through the access port and the loading door while both the access port and the loading door remain rotationally static.

4. The washing apparatus of claim 3, further comprising a fluid inlet engageable with an external fluid supply to allow fluid to enter the cylindrical holding tank through the cylindrical wall portion of the cylindrical holding tank.

5. The washing apparatus of claim 4, wherein the fluid inlet comprises a hose adapter to receive fluid from an external fluid supply and one or more sprayers adapted to spray fluid into the cylindrical holding tank and oriented to spray fluid onto the tumbler cage.

6. The washing apparatus of claim 4, further comprising a fluid outlet to allow fluid to exit the cylindrical holding tank through the cylindrical wall portion of the cylindrical holding tank.

7. The washing apparatus of claim 4, wherein the support assembly comprises two or more axles, wherein the axles engage the cylindrical holding tank and allow the cylindrical holding tank to rotate around the longitudinal axis.

8. The washing apparatus of claim 7, wherein each axle has a plurality of rollers adapted to rotate on the axle, and wherein the rollers engage the cylindrical holding tank and allow the cylindrical holding tank to rotate around the longitudinal axis.

9. The washing apparatus of claim 8, wherein the exterior side of the wall portion of the cylindrical holding tank has one or more circumferential guides, wherein each circumferential guide is engageable with one or more of the rollers.

10. A method of washing material with the apparatus of claim 7 comprising:
situating material to be washed for washing by aligning the cylindrical holding tank access port and the tumbler cage loading port and placing the material to be washed into the tumbler cage;
securing the cylindrical holding tank access port with a cylindrical holding tank loading door and the tumbler cage loading port with a tumbler cage loading door;
rinsing the material by engaging the fluid inlet with an external fluid supply to allow fluid to enter the cylindrical holding tank and spray the material with fluid and allow the fluid to pass through the fluid outlet;
filling the cylindrical holding tank with fluid by closing the fluid outlet and allowing the fluid to fill the cylindrical holding tank at least until the fluid contacts the material in the tumbler cage;
agitating the material by turning the tumbler cage;
opening the fluid outlet and allowing the fluid to pass through the fluid outlet;
rinsing the material again by engaging the fluid inlet with an external fluid supply to allow fluid to enter the cylindrical holding tank and spray the material with fluid and allowing the fluid to pass through the fluid outlet; and
removing the washed material from the apparatus by rotating the cylindrical holding tank until the holding tank access port faces downward, opening the cylindrical holding tank loading door, rotating the tumbler cage until the tumbler cage access port is aligned with the holding tank access port, opening the tumbler cage loading door and allowing the washed material to fall from tumbler cage and through the holding tank access port.

11. The method of washing material of claim 10, wherein the material is lightweight expanded clay aggregate.

12. The method of washing material of claim 11, wherein filling the cylindrical holding tank with fluid further comprises adding a cleaning solution to the fluid.

13. The method of washing material of claim 12, wherein the cleaning solution is bleach.

14. The method of washing material of claim 10, wherein removing the washed material from the apparatus further comprises placing a container below the apparatus and allowing the washed material to fall from tumbler cage and through the holding tank access port into the container.
